(19) United States
(12) Patent Application Publication
(10) Pub. No.: US 2023/0035370 A1
(43) Pub. Date: Feb. 2, 2023

(54) DRIVE DEVICE FOR ELECTRIC MOTOR

(71) Applicant: HITACHI ASTEMO, LTD., Hitachinaka-shi, Ibaraki (JP)

(72) Inventors: Shimon KISHIRA, Hitachinaka-shi, Ibaraki (JP); Makoto KOBAYASHI, Hitachinaka-shi, Ibaraki (JP)

(73) Assignee: HITACHI ASTEMO, LTD., Hitachinaka-shi, Ibaraki (JP)

(21) Appl. No.: 17/783,982

(22) PCT Filed: Dec. 7, 2020
(86) PCT No.: PCT/JP2020/045445

§ 371 Date: Jun. 9, 2022

(30) Foreign Application Priority Data
Dec. 10, 2019 (JP) 2019-223053

(51) Int. Cl. H02P 23/00

(52) U.S. Cl. CPC H02P 23/00

(57) ABSTRACT

A drive device for an electric motor according to the present invention includes a first relay that turns a power supply line on and off leading from a power supply to an electric motor, a resistor provided on a bypass line that bypasses the first relay, a second relay that turns the bypass line on and off, a relay control circuit that outputs a relay control signal common to the first relay and the second relay, and a delay unit that delays the turn-on timing based on the relay control signal of the first relay later than the turn-on timing based on the relay control signal of the second relay. This configuration makes it possible to add a function for suppressing an inrush current without increasing the number of output connectors of a relay control circuit.

### TECHNICAL FIELD

The present invention relates to a drive device for an electric motor. The drive device has a function of suppressing an inrush current that is generated when power is turned on.

### BACKGROUND ART

An inrush-current suppression circuit disclosed in Patent Document 1 includes a first resistor R1 and a first switching device SW1 that are electrically connected to each other, a change-over switching device SW3 connected in parallel with the first resistor R1 and the first switching device SW1, a voltage detection circuit that detects an inter-terminal voltage of a load, and a current adjuster that adjusts the current value of the first resistor R1 according to the inter-terminal voltage detected by the voltage detection circuit.

### REFERENCE DOCUMENT LIST

### Patent Document

Patent Document 1: JP 2019-122158 A

### SUMMARY OF THE INVENTION

### Problem to be Solved by the Invention

Here, as a means for suppressing an inrush current of an electric motor, a means that supplies power via a resistor at power-on may be used.

However, when a configuration in which a relay control circuit outputs a first relay control signal and a second relay control signal is employed to separately control a first relay that turns a line on and off for supplying power via a resistor and a second relay that turns a line on and off for supplying power without using a resistor, the number of output connectors (in other words, the number of output terminals) of the relay control circuit needs to be increased to add a function for suppressing the inrush current and the specification of the relay control circuit needs to be changed.

The present invention was made in view of problems in the related art, and an object of the present invention is to provide a drive device for an electric motor to which a function for suppressing an inrush current can be added without increasing the number of output connectors of a relay control circuit.

### Means for Solving the Problem

For the above object, a drive device for an electric motor according to an aspect of the present invention includes a first relay that turns a power supply line on and off leading from a power supply to an electric motor, a resistor provided on a bypass line that bypasses the first relay, a second relay that turns the bypass line on and off, a relay control circuit that outputs a relay control signal common to the first relay and the second relay, and a delay unit that delays the turn-on timing based on the relay control signal of the first relay later than the turn-on timing based on the relay control signal of the second relay.

### Effects of the Invention

The present invention makes it possible to add a function for suppressing an inrush current without increasing the number of output connectors of a relay control circuit.

### BRIEF DESCRIPTION OF THE DRAWINGS

FIG. 1 is a circuit diagram illustrating a drive device according to a first embodiment;

FIG. 2 is a timing chart for explaining operations of the drive device of the first embodiment at power-on;

FIG. 3 is a circuit diagram illustrating a drive device according to a second embodiment;

FIG. 4 is a timing chart for explaining operations of the drive device of the second embodiment at power-on;

FIG. 5 is a circuit diagram illustrating a drive device according to a third embodiment; and

FIG. 6 is a timing chart for explaining operations of the drive device of the third embodiment at power-on.

### MODE FOR CARRYING OUT THE INVENTION

Embodiments of the present invention are described below.

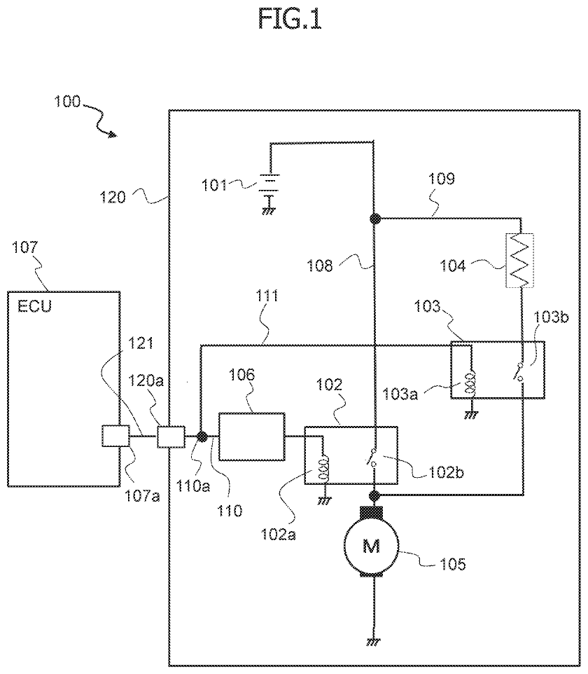

FIG. 1 is a circuit diagram illustrating a drive device for an electric motor according to a first embodiment.

A drive device 100 includes a battery 101 used as a power supply, a first relay 102, a second relay 103, a resistor 104, an electric motor 105, a delay circuit 106 constituting a delay unit, and an electronic control unit (ECU) 107.

First relay 102, second relay 103, resistor 104, electric motor 105, and delay circuit 106 constitute a relay module 120.

Electric motor 105 is, for example, a direct-current motor used to drive a compressor in an air suspension system of an automobile.

First relay 102 is a mechanical relay (in other words, a contact relay) including a first coil 102a and a first contact 102b. Similarly, second relay 103 is a mechanical relay (in other words, a contact relay) including a second coil 103a and a second contact 103b.

ECU 107 mainly includes a microcomputer including a microprocessor unit (MPU), a read-only memory (ROM), and a random-access memory (RAM), and outputs a relay control signal RCS (specifically, a relay drive voltage signal), which is common to first relay 102 and second relay 103, from an output connector 107a.

That is, ECU 107 includes a function as a relay control circuit that outputs the relay control signal RCS.

Output connector 107a of ECU 107 and an input connector 120a of relay module 120 are electrically connected to each other via a harness 121.

First relay 102 is disposed on a power supply line 108 leading from battery 101 to electric motor 105. First relay 102 controls turning power supply line 108 on and off, in other words, controls turning the power supply on and off to electric motor 105 via power supply line 108.

In addition, a series circuit of resistor 104 and second relay 103 is disposed on a bypass line 109 that electrically connects battery 101 to electric motor 105 while bypassing first relay 102.

That is, first relay 102 and the series circuit of resistor 104 and second relay 103 are connected in parallel with each other; and second relay 103 controls turning bypass line 109 on and off, in other words, controls turning the power supply on and off to electric motor 105 via bypass line 109.

Delay circuit 106 is disposed on a first relay drive line 110 that electrically connects input connector 120a of relay module 120 to first coil 102a of first relay 102.

Delay circuit 106 delays the relay control signal RCS output by ECU 107 and outputs the delayed relay control signal RCS to first coil 102a. For example, delay circuit 106 is implemented by an analog low-pass filter such as an on-delay timer circuit or an RC circuit implemented by a combination of a resistor and a capacitor.

Furthermore, a branch 110a provided on first relay drive line 110 between input connector 120a and delay circuit 106 is electrically connected to second coil 103a of second relay 103 via a second relay drive line 111.

Thus, first relay 102 is configured to receive the relay control signal RCS via delay circuit 106, and second relay 103 is configured to receive the relay control signal RCS not via delay circuit 106.

That is, drive device 100 illustrated in FIG. 1 includes a function of a delay unit that turns on first relay 102 with the relay control signal RCS delayed by delay circuit 106, turns on second relay 103 with the relay control signal RCS before being delayed by delay circuit 106, i.e., the relay control signal RCS input to delay circuit 106, and thereby delays the turn-on timing based on the relay control signal RCS of first relay 102 later than the turn-on timing based on the relay control signal RCS of second relay 103.

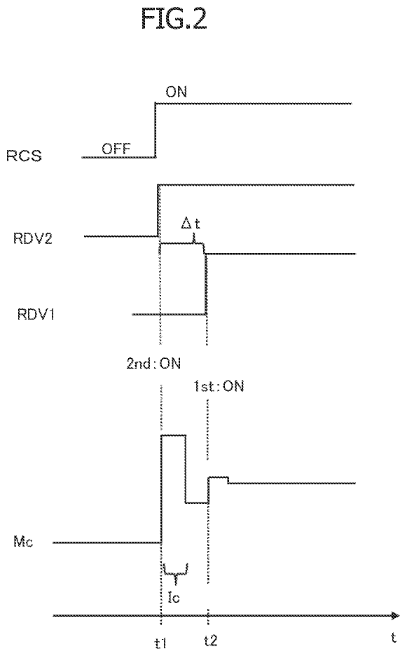

FIG. 2 is a timing chart that illustrates operations in drive device 100 of FIG. 1 at power-on, and specifically, illustrates correlation among the relay control signal RCS, the on-off states of first relay 102 and second relay 103, and a motor current Mc when electric motor 105 is powered on.

When, at time t1 in FIG. 2, ECU 107 raises the relay control signal RCS stepwise from off to on, in other words, raises the voltage of the relay control signal RCS stepwise from zero to a predetermined level, second relay 103, which directly receives the relay control signal RCS as a drive voltage RDV2, is switched from the off state to the on state, and power is supplied from battery 101 to electric motor 105 via resistor 104 and second relay 103.

Because the relay control signal RCS is input to first relay 102 via delay circuit 106, at time t2 that is delayed by a predetermined period Δt from time t1, a drive voltage RDV1 of first relay 102 rises to a level at which first relay 102 is turned on and first relay 102 is switched from the off state to the on state.

That is, delay circuit 106 delays the turn-on timing based on the relay control signal RCS of first relay 102 later than the turn-on timing based on the relay control signal RCS of second relay 103.

When the power is turned on at time t1, because power is supplied to electric motor 105 via resistor 104, an inrush current Ic can be suppressed compared with a case in which power is supplied without using resistor 104.

Also, after the inrush current Ic is suppressed, because first relay 102 is switched to the on state and power supply line 108, which supplies power without using resistor 104, is turned on, useless power consumption on and after time t2 is suppressed.

With drive device 100 described above, ECU 107 can turn on first relay 102 with a delay after turning on second relay 103, by outputting the relay control signal RCS common to first relay 102 and second relay 103 from output connector 107a.

Even when delay circuit 106 is not provided, if ECU 107 is configured to separately output a relay control signal for controlling first relay 102 and a relay control signal for controlling second relay 103, it is possible to control the turning on and off of power supply line 108 and bypass line 109, similarly to drive device 100 including delay circuit 106.

However, if a connector for outputting a relay control signal RCS for controlling second relay 103 is added to ECU 107, in addition to a connector for outputting a relay control signal RCS for controlling first relay 102, to add a function for suppressing the inrush current Ic, the number of output connectors of ECU 107 needs to be increased, which results in a change in the specifications of ECU 107.

In contrast, with a configuration in which the relay control signal RCS output by ECU 107 is directly input to second relay 103 and the relay control signal RCS delayed by delay circuit 106 is input to first relay 102, it is possible to add a function for suppressing the inrush current Ic without increasing the number of output connectors of ECU 107.

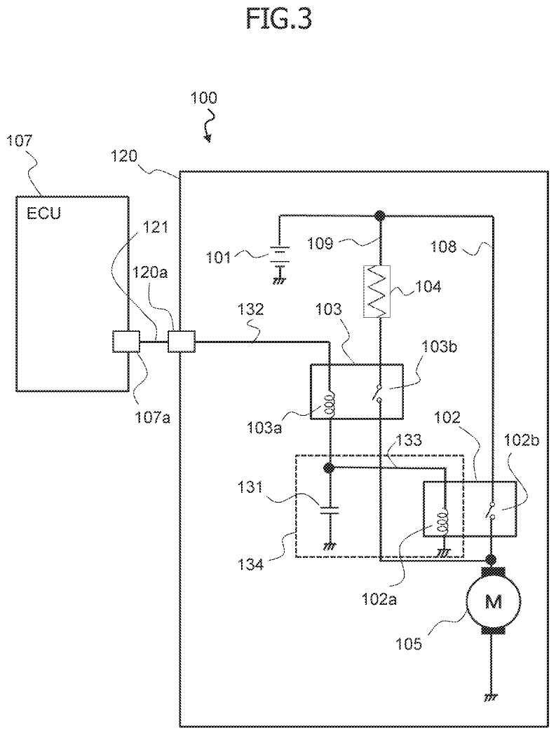

FIG. 3 is a circuit diagram illustrating a drive device for an electric motor according to a second embodiment.

The same reference numbers assigned to components of drive device 100 in FIG. 1 are assigned to the corresponding components in FIG. 3, and detailed descriptions of these components are omitted.

A drive device 100 in FIG. 3 includes a relay module 120 including a first relay 102, a second relay 103, a resistor 104, an electric motor 105, and a capacitor 131; a battery 101; and an ECU 107.

An output connector 107a of ECU 107 and an input connector 120a of relay module 120 are electrically connected to each other via a harness 121.

First relay 102 is disposed on a power supply line 108 that electrically connects battery 101 to electric motor 105, and a series circuit of resistor 104 and second relay 103 is disposed on a bypass line 109 that electrically connects battery 101 to electric motor 105 while bypassing first relay 102.

Also, input connector 120a of relay module 120 and a second coil 103a of second relay 103 are electrically connected to each other via a first relay drive line 132, and a capacitor 131 is connected in series between second coil 103a and a ground GND.

Furthermore, first relay drive line 132 between second coil 103a and capacitor 131 is electrically connected to a first coil 102a of first relay 102 via a second relay drive line 133.

That is, capacitor 131 is connected in parallel with first coil 102a of first relay 102, and second coil 103a is connected in series with this parallel circuit at a position upstream of the parallel circuit. In other words, first coil 102a is connected in series with second coil 103a at a position downstream of second coil 103a, and capacitor 131 is connected in parallel with first coil 102a.

Here, the parallel circuit implemented by a combination of capacitor 131 and first coil 102a constitutes an LC low-pass filter 134 (in other words, an L-type filter) that functions as a delay circuit.

That is, drive device 100 of FIG. 3 is configured such that first relay 102 is turned on with the relay control signal RCS delayed by LC low-pass filter 134 used as a delay circuit and second relay 103 is turned on with the relay control signal RCS before being delayed by LC low-pass filter 134 in order to delay the turn-on timing based on the relay control signal RCS of first relay 102 later than the turn-on timing based on the relay control signal RCS of second relay 103.

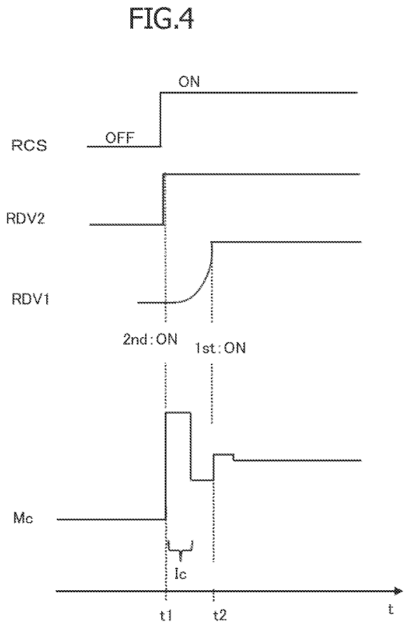

FIG. 4 is a timing chart that illustrates operations in drive device 100 of FIG. 3 at power-on, and specifically, illustrates correlation among the relay control signal RCS, the on-off states of first relay 102 and second relay 103, and a motor current Mc when electric motor 105 is powered on.

When, at time t1 in FIG. 4, ECU 107 raises the relay control signal RCS stepwise from off to on, in other words, raises the voltage of the relay control signal RCS stepwise from zero to a predetermined level, second relay 103, which directly receives the relay control signal RCS as a drive voltage RDV2, is switched from the off state to the on state, and power is supplied from battery 101 to electric motor 105 via resistor 104 and second relay 103.

First coil 102a of first relay 102 corresponds to an output end of LC low-pass filter 134, and first relay 102 is driven by a drive voltage RDV1 that is the relay control signal RCS delayed by LC low-pass filter 134.

Therefore, at time t2 delayed by a predetermined period Δt from time t1, the drive voltage RDV1 of first relay 102 rises to a level at which first relay 102 is turned on, and first relay 102 is switched from the off state to the on state.

That is, LC low-pass filter 134, which functions as a delay circuit, delays the turn-on timing based on the relay control signal RCS of first relay 102 later than the turn-on timing based on the relay control signal RCS of second relay 103.

When the power is turned on at time t1, because power is supplied to electric motor 105 via resistor 104, the inrush current Ic can be suppressed compared with a case in which power is supplied without using resistor 104.

Also, after the inrush current Ic is suppressed, because first relay 102 is switched to the on state and power supply line 108, which supplies power without using resistor 104, is turned on, useless power consumption on and after time t2 is suppressed.

Also, with drive device 100 of FIG. 3, ECU 107 does not need to separately output a relay control signal RCS for driving first relay 102 and a relay control signal RCS for driving second relay 103 used to suppress the inrush current Ic. This configuration makes it possible to add a function for suppressing the inrush current Ic without increasing the number of output connectors of ECU 107.

Furthermore, in drive device 100 of FIG. 3, LC low-pass filter 134 functioning as a delay circuit is implemented by a combination of capacitor 131 and first coil 102a of first relay 102. This configuration makes it easier to provide a delay circuit and makes it possible to simplify the circuit configuration of drive device 100.

Here, to delay the turn-on timing based on the relay control signal RCS of first relay 102 by a predetermined period later than the turn-on timing based on the relay control signal RCS of second relay 103, the specification of first coil 102a constituting LC low-pass filter 134 may be made different from the specification of second coil 103a.

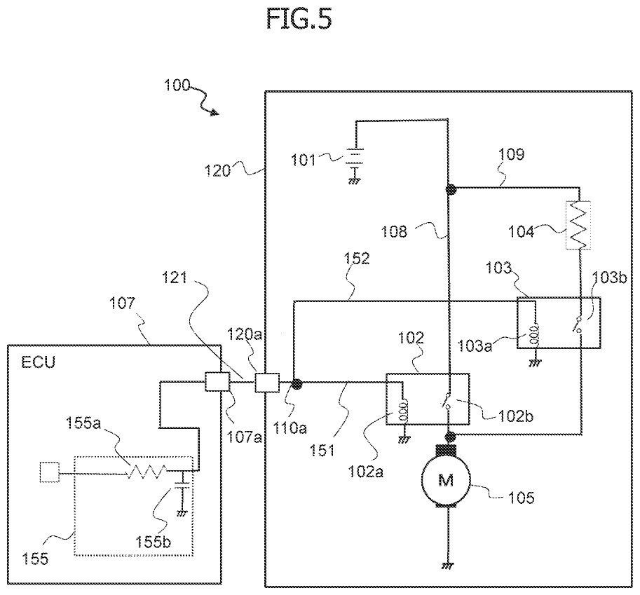

FIG. 5 is a circuit diagram illustrating a drive device for an electric motor according to a third embodiment.

The same reference numbers assigned to components of drive device 100 in FIG. 1 are assigned to the corresponding components in FIG. 5, and detailed descriptions of these components are omitted.

A drive device 100 in FIG. 5 includes a relay module 120 including a battery 101, a first relay 102, a second relay 103, a resistor 104, and an electric motor 105; and an ECU 107.

An output connector 107a of ECU 107 and an input connector 120a of relay module 120 are electrically connected to each other via a harness 121.

First relay 102 is disposed on a power supply line 108 that electrically connects battery 101 to electric motor 105, and a series circuit of resistor 104 and second relay 103 is disposed on a bypass line 109 that electrically connects battery 101 to electric motor 105 while bypassing first relay 102.

Also, input connector 120a of relay module 120 and first coil 102a of first relay 102 are electrically connected to each other via a first relay drive line 151, and a second relay drive line 152, which branches and extends from first relay drive line 151, is connected to second coil 103a of second relay 103.

With this configuration, a relay control signal RCS output by ECU 107 is input to first relay 102 and second relay 103 without change.

On the other hand, ECU 107 includes an internal delay circuit 155 that delays the relay control signal RCS and outputs, from output connector 107a, the relay control signal RCS that has passed through delay circuit 155, as the relay control signal RCS common to first relay 102 and second relay 103.

Delay circuit 155 is, for example, an analog low-pass filter implemented by an RC circuit formed by combining a resistor 155a and a capacitor 155b. When an input signal (step signal) of delay circuit 155 rises, the output of delay circuit 155 gradually changes with a rise delay time up to the final value.

Also, the voltage at which first relay 102 is turned on is set higher than the voltage at which second relay 103 is turned on, and drive device 100 is configured such that second relay 103 is turned on first, and first relay 102 is turned on with a delay after a predetermined period during the rising response of the relay control signal RCS output by ECU 107 (in other words, delay circuit 155 that is an analog low-pass filter).

That is, when turning on electric motor 105, ECU 107 supplies, to first relay 102 and second relay 103, the relay control signal RCS that gradually changes up to the final value with a rising delay time.

Here, because the voltage at which first relay 102 is turned on is set higher than the voltage at which second relay 103 is turned on, during the rising response, the voltage level of the relay control signal RCS first reaches the voltage at which second relay 103 is turned on, and then reaches, with a delay, the voltage at which first relay 102 is turned on.

Accordingly, although the same relay control signal RCS is input to first relay 102 and second relay 103, the turn-on timing based on the relay control signal RCS of first relay 102 is delayed later than the turn-on timing based on the same relay control signal RCS of second relay 103 due to the difference in the on-voltage.

Thus, a delay unit for delaying the turn-on timing based on the relay control signal RCS of first relay 102 later than the turn-on timing based on the relay control signal RCS of second relay 103 is implemented by setting different on-voltages for first relay 102 and second relay 103 and by configuring ECU 107 to output the relay control signal RCS with a rise delay time.

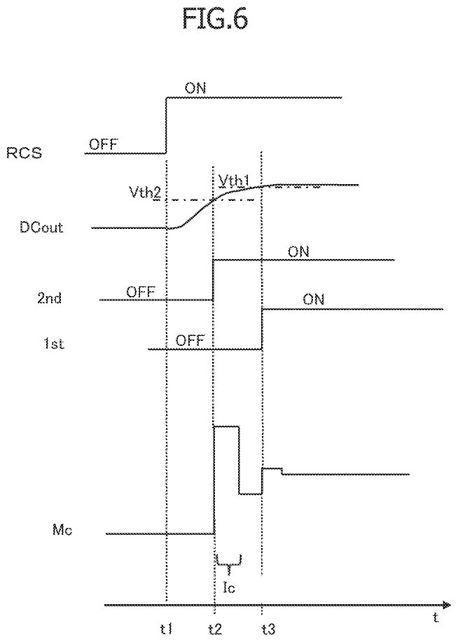

FIG. 6 is a timing chart that illustrates operations in drive device 100 of FIG. 5 at power-on, and specifically, illustrates correlation among the relay control signal RCS, the on-off states of first relay 102 and second relay 103, and a motor current Mc when electric motor 105 is powered on.

In FIG. 6, ECU 107 raises the relay control signal RCS stepwise from off to on at time t1 based on a command to start electric motor 105, and an output DCout of delay circuit 155 gradually changes to the final value with a rise delay time from time t1.

At time t2 during the rising response, the voltage of the relay control signal RCS (in other words, the drive voltage RDV2 of second relay 103) reaches an on-voltage Vth2 of second relay 103, and second relay 103 is turned on. At subsequent time t3, the voltage of the relay control signal RCS (in other words, the drive voltage RDV1 of first relay 102) reaches an on-voltage Vth1 (Vth1>Vth2) of first relay 102, and first relay 102 is turned on.

When electric motor 105 is powered on at time t2, because power is supplied via resistor 104, the inrush current Ic can be suppressed compared with a case in which power is supplied without using resistor 104.

Also, after the inrush current Ic is suppressed, first relay 102 is switched to the on state at time t3 and power supply line 108, which supplies power without using resistor 104, is turned on. As a result, useless power consumption after time t3 is suppressed.

Also, with drive device 100 of FIG. 5, ECU 107 does not need to separately output a relay control signal RCS for driving first relay 102 and a relay control signal RCS for driving second relay 103 for suppressing the inrush current Ic. This configuration makes it possible to add a function for suppressing the inrush current Ic without increasing the number of output connectors of ECU 107.

Furthermore, with drive device 100 of FIG. 5, it is possible to delay the turn-on timing based on the relay control signal RCS of first relay 102 later than the turn-on timing based on the relay control signal RCS of second relay 103 without adding electronic components to relay module 120.

The technical ideas described in the above embodiments may be used in any appropriate combination as long as they do not conflict with each other.

Although the present invention is specifically described above with reference to preferred embodiments, it is apparent to one skilled in the art that variations of the embodiments can be made based on the basic technical concept and the teachings of the present invention.

For example, although each of drive devices 100 illustrated in FIG. 1, FIG. 3, and FIG. 5 is comprised of ECU 107 including a relay control circuit and relay module 120 and output connector 107a of ECU 107 and input connector 120a of relay module 120 are connected to each other via a harness, each drive device 100 may be implemented by a system in which first relay 102, second relay 103, and resistor 104 are not integrated into a module.

Furthermore, in drive device 100 illustrated in FIG. 1 or FIG. 5, contactless relays (in other words, semiconductor relays) may be used as first relay 102 and second relay 103.

### REFERENCE SYMBOL LIST

101 battery (power supply)
102 first relay
102a first coil
102b first contact
103 second relay
103a second coil
103b second contact
104 resistor
105 electric motor
106 delay circuit (delay unit)
107 ECU (relay control circuit)
108 power supply line
109 bypass line
134 LC low-pass filter (delay circuit, delay unit)
155 delay circuit

1. A drive device for an electric motor, the drive device comprising:
a first relay that turns a power supply line on and off leading from a power supply to an electric motor;
a resistor provided on a bypass line that bypasses the first relay;
a second relay that turns the bypass line on and off;
a relay control circuit that outputs a relay control signal common to the first relay and the second relay; and
a delay unit that delays a turn-on timing based on the relay control signal of the first relay later than a turn-on timing based on the relay control signal of the second relay.

2. The drive device for an electric motor as claimed in claim 1,
wherein the delay unit
includes a delay circuit that delays the relay control signal,
turns on the first relay with the relay control signal delayed by the delay circuit, and
turns on the second relay with the relay control signal which has not yet been delayed by the delay circuit.

3. The drive device for an electric motor as claimed in claim 2, wherein
the first relay is a mechanical relay including a first coil and a first contact, and
the delay circuit is a low-pass filter implemented by a combination of the first coil and a capacitor.

4. The drive device for an electric motor as claimed in claim 3, wherein
the second relay is a mechanical relay including a second coil and a second contact,
the first coil is connected in series with the second coil at a position downstream of the second coil, and
the capacitor is connected in parallel with the first coil.

5. The drive device for an electric motor as claimed in claim 1,
wherein the delay unit
sets a voltage at which the first relay is turned on higher than a voltage at which the second relay is turned on,
causes the relay control circuit to output the relay control signal with a rise delay time, and
turns on the first relay after turning on the second relay during a rising response of the relay control signal.

6. The drive device for an electric motor as claimed in claim 5,
wherein the relay control circuit
includes a delay circuit that delays the relay control signal, and
outputs an output of the delay circuit as the relay control signal common to the first relay and the second relay.

7. The drive device for an electric motor as claimed in claim 1, wherein
the relay control circuit is included in an ECU,
the first relay, the resistor, the second relay, and the electric motor constitute a relay module, and
an output connector of the ECU that outputs the relay control signal is connected to an input connector of the relay module.
